(19) United States
(12) Patent Application Publication
(10) Pub. No.: US 2017/0299688 A1
(43) Pub. Date: Oct. 19, 2017

(54) BEACON TRANSMITTING DEVICE AND BEACON TRANSMITTING METHOD

(71) Applicant: Daisuke HATA, Saitama (JP)

(72) Inventor: Daisuke HATA, Saitama (JP)

(73) Assignee: Ricoh Company, Ltd., Tokyo (JP)

(21) Appl. No.: 15/478,468

(22) Filed: Apr. 4, 2017

(30) Foreign Application Priority Data
Apr. 15, 2016 (JP) 2016-081738
Oct. 27, 2016 (JP) 2016-211005

(51) Int. Cl. G01S 5/02; H04W 72/12

(52) U.S. Cl. CPC G01S 5/0215; G01S 5/021; H04W 72/1231

(57) ABSTRACT

A beacon transmitting device is provided that includes a memory storing a program and a processor configured to execute the program to implement processes of receiving transmission timings, transmission formats, and transmission data for a plurality of beacon signal specifications; registering the transmission timings, the transmission formats, and the transmission data for the plurality of beacon signal specifications in the memory; and sequentially transmitting a plurality of beacon signals of the plurality of beacon signal specifications based on the transmission timings, the transmission formats, and the transmission data registered in the memory.

### CROSS-REFERENCE TO RELATED APPLICATIONS

The present application claims priority under 35 U.S.C. §119 to Japanese Patent Application No. 2016-081738 filed on Apr. 15, 2016 and Japanese Patent Application No. 2016-211005 filed on Oct. 27, 2016, the entire contents of which are incorporated herein by reference.

### BACKGROUND OF THE INVENTION

### 1. Field of the Invention

The present invention relates to a beacon transmitting device and a beacon transmitting method.

### 2. Description of the Related Art

In recent years, beacon devices (beacon transmitting devices) that are capable of transmitting a beacon signal to a terminal device carried by a user are installed in facilities, such as a supermarket, a convenience store, a department store, a specialty shop, and the like, to provide various services. A terminal device that receives a beacon signal from a beacon device can run an application installed in the terminal device to acquire product information from the beacon signal and display the acquired product information on a display unit of the terminal device, for example.

Also, position information services using GPS (Global Positioning System) are becoming widespread mainly in car navigation systems and smart phone applications, for example. However, because GPS is positioning technology using satellite radio waves, it cannot be used indoors or underground where radio waves cannot be received, for example. Thus, in order to provide a position information service to be used indoors, positioning technology other than GPS, such as indoor positioning technology, has to be used. In this respect, PDR (Pedestrian Dead Reckoning) is a known technique for estimating the position of a pedestrian in an indoor or underground environment where positioning cannot be performed using GPS. PDR involves receiving a beacon signal from a beacon device and calculating a position based on the position of the beacon device using an inertial device integrating an acceleration sensor or a geomagnetic sensor, for example, to estimate the position of a pedestrian.

Services using beacon devices are expected to become more popular, and as such, techniques for efficiently installing beacon devices are in demand.

Also, techniques are known for reducing the time required for scanning identification information of beacon devices in an environment where a large number of beacon devices are installed. For example, Japanese Unexamined Patent Publication No. 2015-143631 discloses limiting the beacon devices from which a beacon signal is to be received based on their installation position information.

When providing a new beacon service using a beacon device, a new beacon device may have to be installed. However, in general, places worth providing such new beacon service already have a number of different beacon devices installed therein such that installation of a new beacon device may not be easy. That is, in addition to installation costs including installation work and maintenance after installation, for example, installation space may be limited due to the presence of existing beacon devices, there may be a shortage of power supply outlets, and radio wave interference has to be taken into account (because beacon signals are transmitted asynchronously). As such, securing a suitable installation location for a new beacon device may be quite difficult.

### SUMMARY OF THE INVENTION

One aspect of the present invention is directed to enabling transmission of beacon signals for a plurality of services using one beacon device per location.

According to one embodiment of the present invention, a beacon transmitting device is provided that includes a memory storing a program and a processor configured to execute the program to implement processes of receiving transmission timings, transmission formats, and transmission data for a plurality of beacon signal specifications; registering the transmission timings, the transmission formats, and the transmission data for the plurality of beacon signal specifications in the memory; and sequentially transmitting a plurality of beacon signals of the plurality of beacon signal specifications based on the transmission timings, the transmission formats, and the transmission data registered in the memory.

### BRIEF DESCRIPTION OF THE DRAWINGS

FIG. 1 is a diagram illustrating an example configuration of a system according to a first embodiment of the present invention;

FIG. 2 is a diagram illustrating an example functional configuration of a beacon device;

FIG. 3 is a diagram illustrating an example detailed functional configuration of the beacon device;

FIG. 4 is a diagram illustrating an example functional configuration of a content server;

FIG. 5 is a diagram illustrating an example functional configuration of a mobile terminal;

FIG. 6 is a diagram illustrating an example functional configuration of a beacon management server;

FIG. 7 is a diagram illustrating an example hardware configuration of the beacon device;

FIG. 8 is a diagram illustrating an example hardware configuration of the content server and the beacon management server;

FIG. 9 is a diagram illustrating an example hardware configuration of the mobile terminal;

FIG. 10 is a sequence chart illustrating an example process according to the first embodiment;

FIG. 11 is a diagram illustrating an example configuration of beacon installation information;

FIG. 12 is a diagram illustrating a first example of beacon service information;

FIG. 13 is a diagram illustrating a second example of beacon service information;

FIG. 14 is a diagram illustrating a third example of beacon service information;

FIG. 15 is a diagram illustrating example transmission timings;

FIG. 16 is a diagram illustrating an example functional configuration of the beacon device according to a second embodiment of the present invention;

FIG. 17 is a sequence chart illustrating an example process according to the second embodiment;

FIGS. 18A-18C are diagrams illustrating examples of interference information;

FIGS. 19A and 19B are diagrams illustrating example transmission timings;

FIG. 20 is a diagram illustrating an example functional configuration of the beacon device according to a third embodiment of the present invention;

FIG. 21 is a diagram illustrating an example functional configuration of the beacon management server according to the third embodiment; and

FIG. 22 is a sequence chart illustrating an example process according to the third embodiment.

### DESCRIPTION OF THE EMBODIMENTS

In the following, embodiments of the present invention are described with reference to the accompanying drawings.

### First Embodiment

[Configuration]

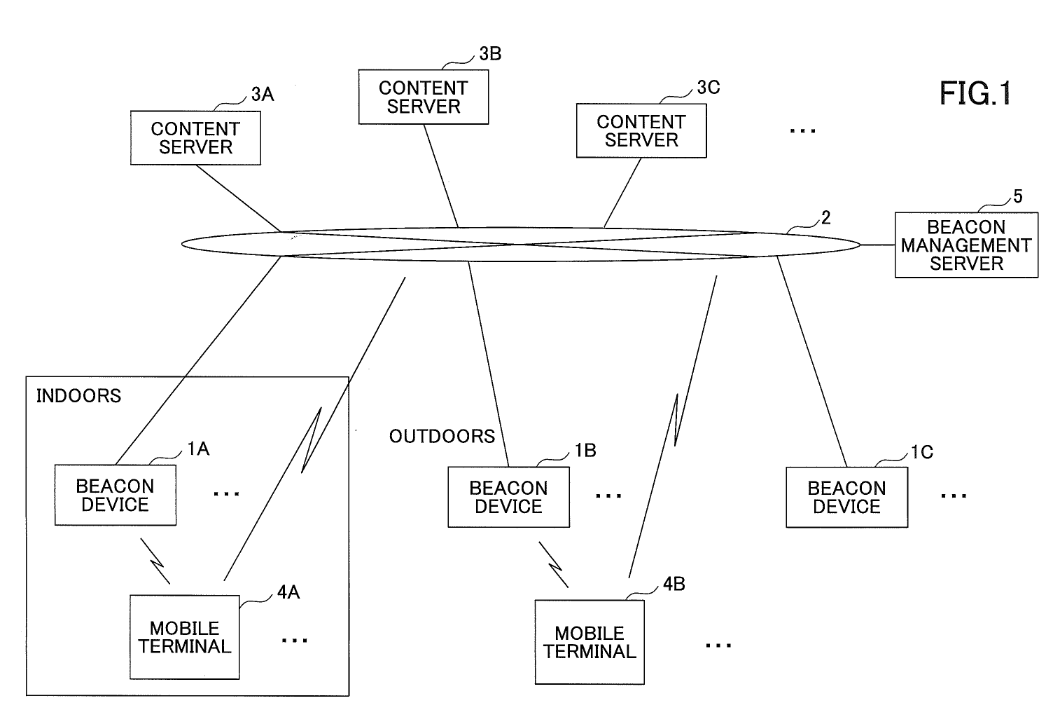

FIG. 1 is a diagram illustrating an example configuration of a system according to a first embodiment of the present invention. In FIG. 1, a plurality of beacon devices 1 (1A, 1B, 1C, . . . ) that transmit beacon signals are installed indoors or outdoors, and these beacon devices 1 are connected to a network 2 by wire or wirelessly. Note that a BLE (Bluetooth Low Energy) device or a WIFI device may be used as the beacon device 1, for example. Because BLE and WIFI are standardized, business operations of receiving orders for beacon signal transmission services from clients may be facilitated by using BLE or WIFI, for example. Also, system construction can be facilitated by using BLE or WIFI, for example. Note that beacon signal transmission may be performed using communication technology other than BLE or WIFI, such as sound waves (ultrasound), for example.

Also, the network 2 is connected to a plurality of content servers 3 (3A, 3B, 3C, . . . ) that are managed with respect to each service or service group and are configured to provide content corresponding to data included in the beacon signals. Mobile terminals 4 (4A, 4B, . . . ), such as smartphones, which may be located indoors or outdoors, can receive a beacon signal from the beacon device 1 by coming close to the beacon device 1, access a corresponding content server 3 via the network 2 by running an internal application, and acquire content corresponding to the beacon signal. Also, a beacon management server 5 that manages the plurality of beacon devices 1 is connected to the network 2.

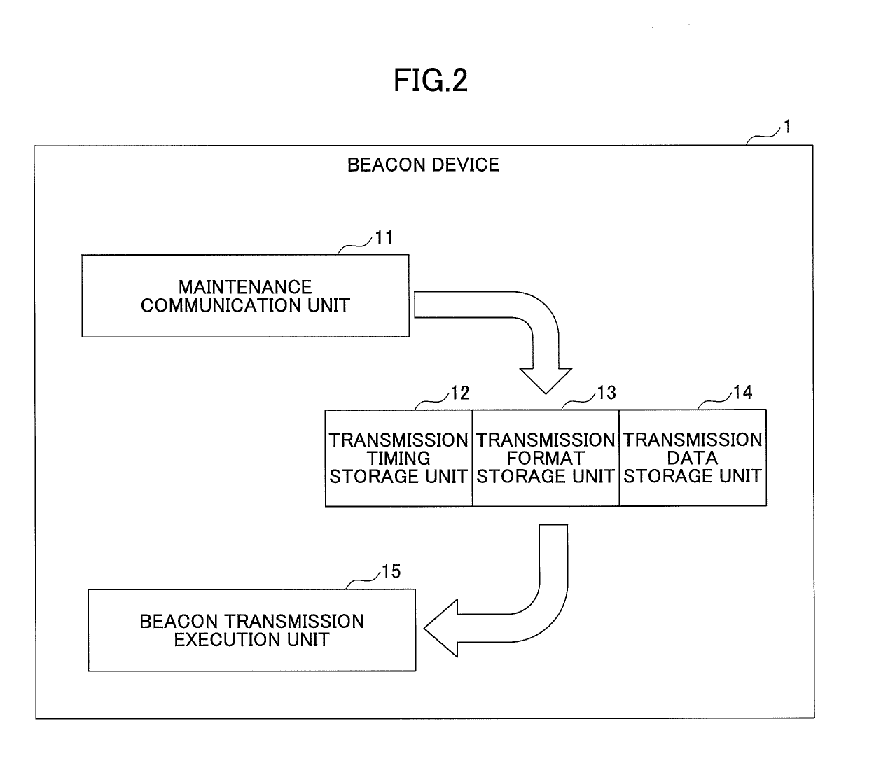

FIG. 2 is a diagram illustrating an example functional configuration of the beacon device 1 (1A, 1B, 1C). In FIG. 2, the beacon device 1 includes a maintenance communication unit 11 and a beacon transmission execution unit 15. The maintenance communication unit 11 receives transmission timings, transmission formats, and transmission data for a plurality of beacon signal specifications corresponding to a plurality of beacon services from the beacon management server 5 at a predetermined timing, and registers the received information in a transmission timing storage unit 12, a transmission format storage unit 13, and a transmission data storage unit 14. The transmission timing storage unit 12, the transmission format storage unit 13, and the transmission data storage unit 14 store a beacon signal specification, a transmission timing, a transmission format, and transmission data for each beacon service in association with each other. The above information may be stored in one table or may be stored in a plurality of tables, for example.

The beacon transmission execution unit 15 transmits the transmission data registered in the transmission data storage unit 14 for each beacon service as a beacon signal to the surroundings, in the transmission format registered in the transmission format storage unit 13, based on the transmission timing registered in the transmission timing storage unit 12.

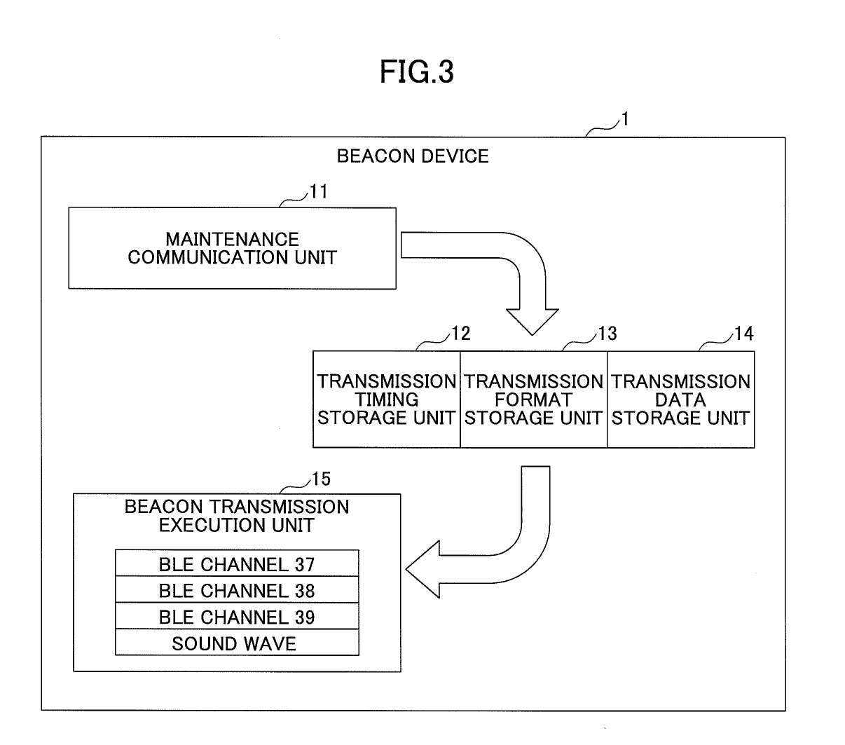

FIG. 3 is a diagram illustrating a more specific functional configuration of the beacon device 1. In FIG. 3, the beacon transmission execution unit 15 uses three advertisement channels, including BLE channels 37, 38, and 39, and sound waves emitted from a speaker. In BLE, three channels out of a total of 40 channels are allocated as advertisement channels for device discovery, and the remaining 37 channels are allocated as data communication channels. For sound waves, only one channel is provided. This is because a microphone built in the mobile terminal 4, such as a smartphone, typically has a frequency band substantially corresponding to an audible sound range, and as such, it is difficult to set up a plurality of channels for the non-audible sound range. The three advertisement channels 37, 38, and 39, and the sound waves can simultaneously transmit beacon signals, and in this way, beacon signals of the same beacon service may be transmitted at the same time, or beacon signals of different beacon services may be transmitted at the same time, for example. By simultaneously transmitting beacon signals of a plurality of beacon services using a plurality of channels and/or sound waves, beacon service orders for transmission of a large number of beacon signals may be efficiently processed, for example.

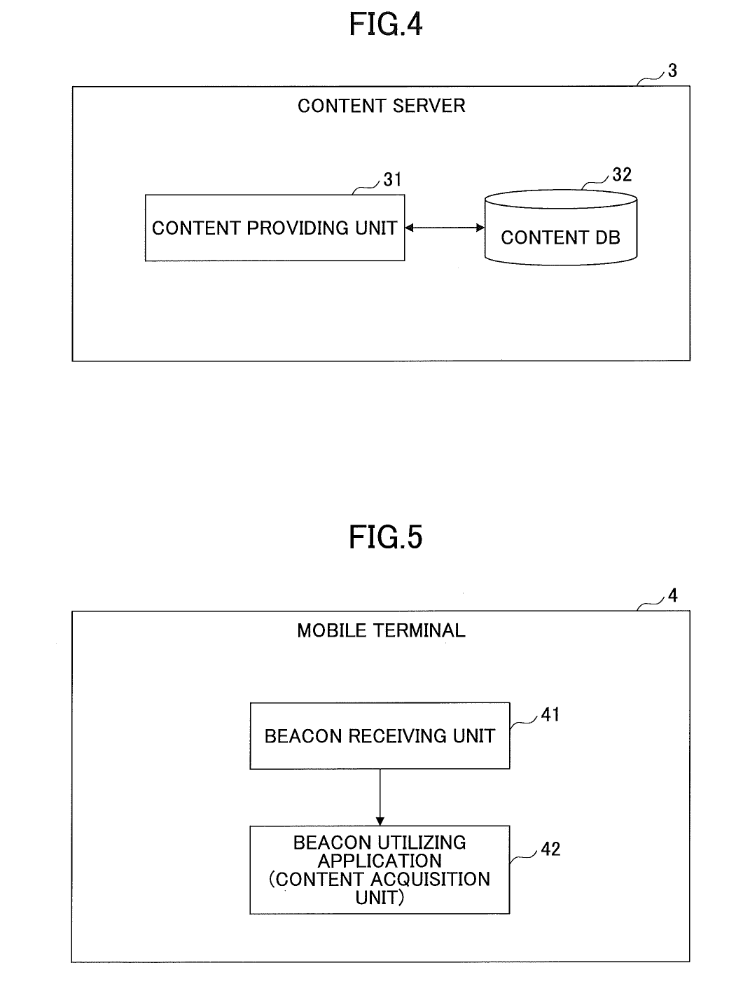

FIG. 4 is a diagram illustrating an example functional configuration of the content server 3 (3A, 3B, 3C). In FIG. 4, the content server 3 includes a content providing unit 31. The content providing unit 31 receives data specifying the beacon device 1 included in a beacon signal from the mobile terminal 4, acquires corresponding content by referring to a content DB (database) 32, and returns the acquired content to the requesting mobile terminal 4.

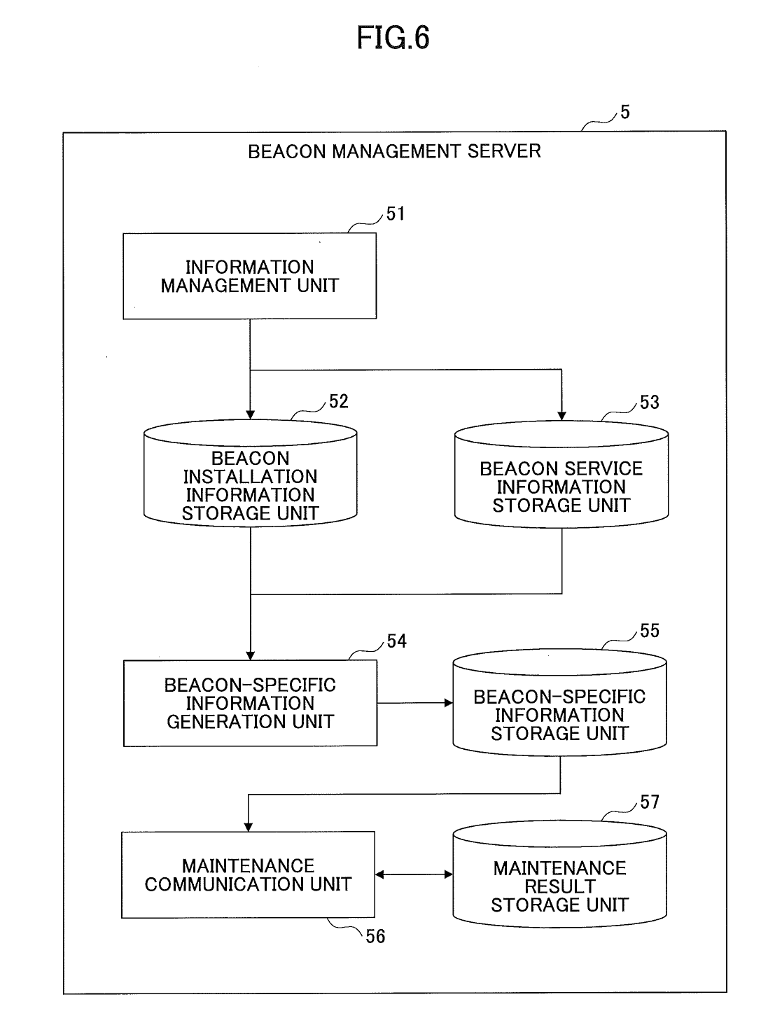

FIG. 5 is a diagram illustrating an example functional configuration of the mobile terminal 4 (4A, 4B). In FIG. 5, the mobile terminal 4 includes a beacon receiving unit 41 and a beacon utilizing application 42. The beacon receiving unit 41 is usually provided in a smartphone and has a function of receiving a beacon signal transmitted from the beacon device 1 according to a communication standard, such as BLE or WIFI. The beacon receiving unit 41 passes data acquired from a received beacon signal to the beacon utilizing application 42 only when the received beacon signal includes a preregistered beacon ID. The beacon utilizing application 42 is a dedicated application provided by a beacon service provider or the like and has a function of accessing the content server 3 based on data included in a beacon signal and acquiring content corresponding to the beacon service.

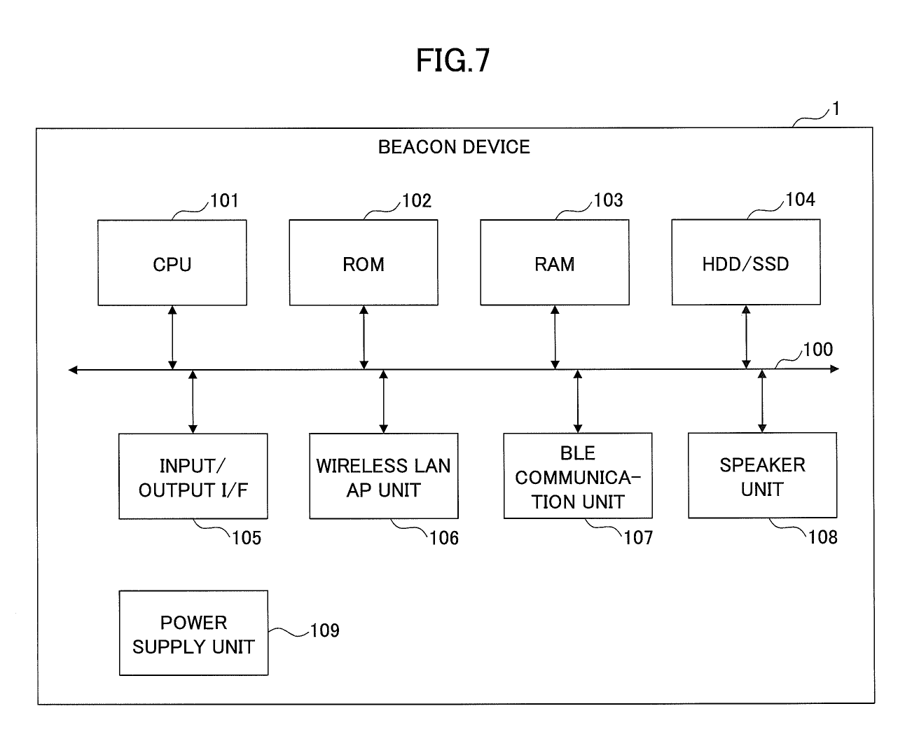

FIG. 6 is a diagram illustrating an example functional configuration of the beacon management server 5. In FIG. 6, the beacon management server 5 includes an information management unit 51, a beacon-specific information generation unit 54, and a maintenance communication unit 56. The information management unit 51 registers beacon installation information including an installation position of the beacon device 1 being managed by the beacon management server 5 in a beacon installation information storage unit 52 and also registers detailed information (beacon service information) relating to a beacon service ordered by the beacon device 1 in a beacon service information storage unit 53. Based on the beacon installation information registered in the beacon installation information storage unit 52 and the beacon service information registered in the beacon service information storage unit 53, the beacon-specific information generation unit 54 generates setting information (beacon-specific information) for each beacon device 1 and registers the generated information in a beacon-specific information storage unit 55. The maintenance communication unit 56 performs maintenance communication with the beacon device 1 to set up the beacon device 1 based on the beacon-specific information registered in the beacon-specific information storage unit 55. Further, the maintenance communication unit 56 registers a result of the maintenance communication in a maintenance result storage unit 57. Note that the information stored and managed by the beacon management server 5 is described in detail below.

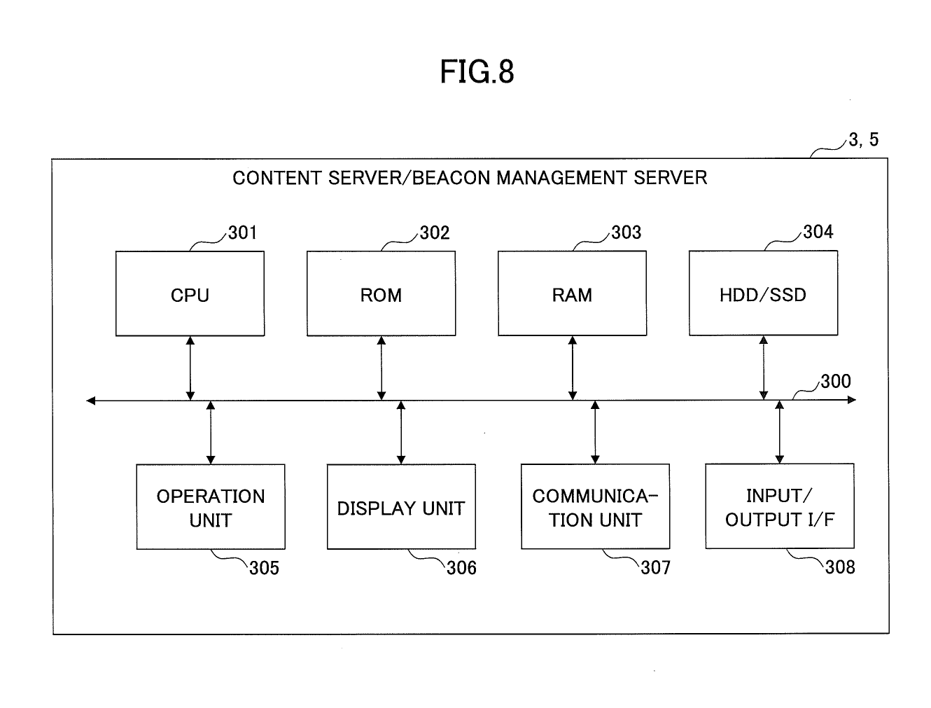

FIG. 7 is a diagram illustrating an example hardware configuration of the beacon device 1. In FIG. 7, the beacon device 1 includes a CPU (Central Processing Unit) 101, a ROM (Read Only Memory) 102, a RAM (Random Access Memory) 103, and a HDD (Hard Disk Drive)/SSD (Solid State Drive) 104. The CPU 101 comprehensively controls operations of the beacon device 1 by executing a program stored in the ROM 102 or the HDD/SSD 104 using the RAM 103 as a work area, for example.

Also, the beacon device 1 includes an input/output I/F (interface) 105, a wireless LAN AP (Local Area Network Access Point) unit 106, a BLE communication unit 107, and a speaker unit 108. The input/output I/F 105 is an interface for accepting user operations and the like. The wireless LAN AP unit 106 is an interface for communicating with another information processing apparatus via a wireless LAN and is used for transmitting a beacon signal according to a standard such as WIFI. The BLE communication unit 107 establishes communication using BLE, and is used for transmitting a beacon signal according to the BLE standard. The speaker unit 108 transmits an ultrasonic signal and is used for transmitting a beacon signal using a sound wave.

Also, a power supply unit 109 supplies power to each of the above hardware elements of the beacon device 1. The power supply unit 109 may be a battery, a solar cell, a USB (Universal Serial Bus) power supply, a PoE (Power over Ethernet) power supply, or the like.

The functions of the beacon device 1 described above with reference to FIG. 2 or FIG. 3 may be implemented by the CPU 101 executing a predetermined program, for example. The program may be acquired via a recording medium or via a network, or the program may be embedded in the ROM 102, for example. Also, the various items of information described above with reference to FIG. 2 or FIG. 3 may be temporarily stored in the RAM 103 and permanently stored in the HDD/SSD 104, for example.

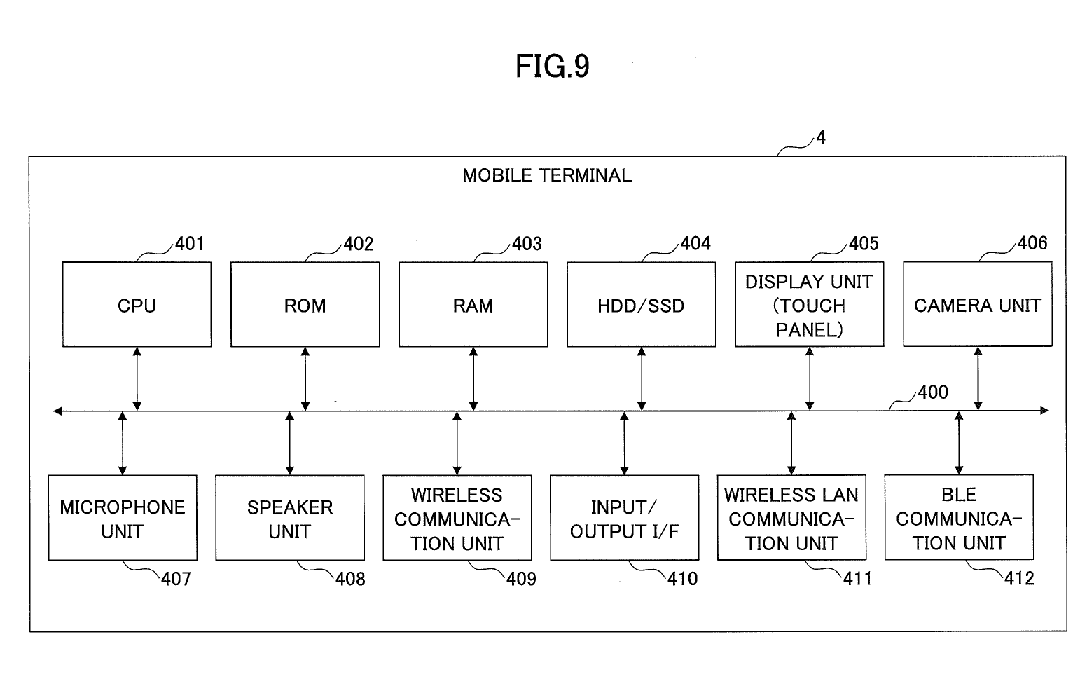

FIG. 8 is a diagram illustrating an example hardware configuration of the content server 3 and the beacon management server 5. In FIG. 8, the content server 3 (or beacon management server 5) includes a CPU 301, a ROM 302, a RAM 303, and an HDD/SSD 304 that are connected to each other via a bus 300. The CPU 301 comprehensively controls operations of the content server 3 by executing a program stored in the ROM 302 or the HDD/SSD 304 using the RAM 303 as a work area, for example.

The content server 3 (or beacon management server 5) also includes an operation unit 305, a display unit 306, a communication unit 307, and an input/output I/F 308. The operation unit 305 accepts a user operation. The display unit 306 displays items, such as an operation menu, a processing state, and the like to a user. The communication unit 307 communicates with another information processing apparatus. The input/output I/F 308 is an interface for inputting and outputting data to/from an external device, for example.

The functions of the content server 3 and the beacon management server 5 described above with reference to FIG. 4 and FIG. 6 may be implemented by the CPU 301 executing a predetermined program, for example. The program may be acquired via a recording medium or via a network, or the program may be embedded in the ROM 302, for example. Note that the various items of information stored in the content server 3 or the beacon management server 5 as described above with reference to FIGS. 4 and 6 may be temporarily stored in the RAM 303 and permanently stored in the HDD/SSD 304, for example.

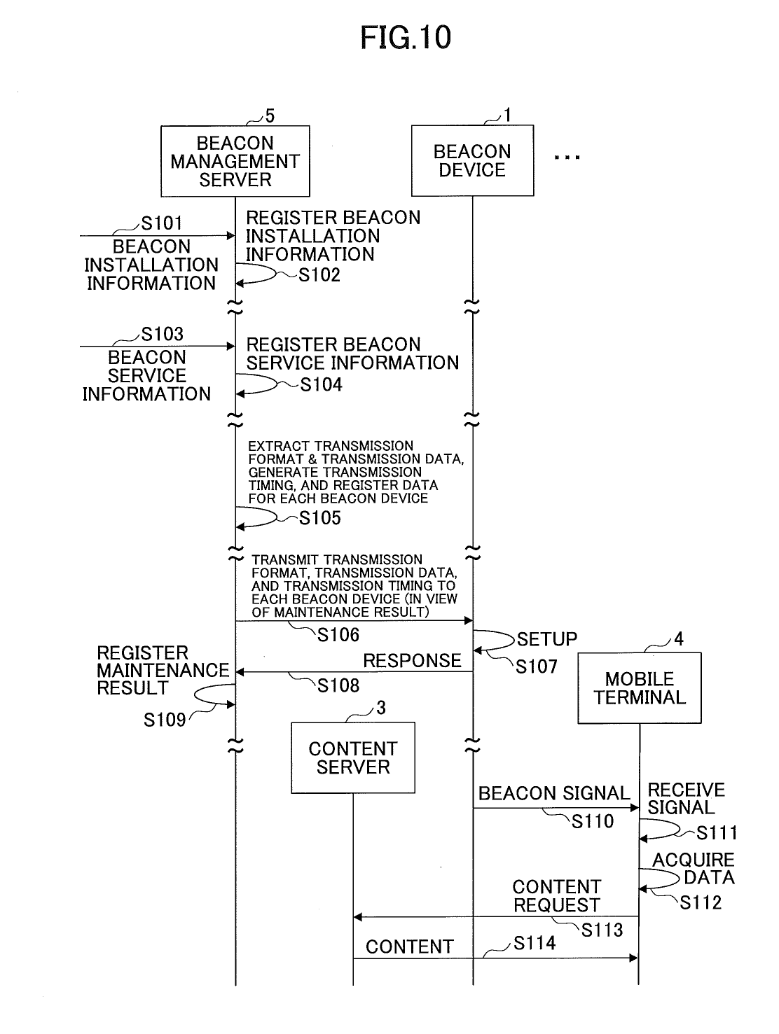

FIG. 9 is a diagram illustrating an example hardware configuration of the mobile terminal 4. In FIG. 9, the mobile terminal 4 includes a CPU 401, a ROM 402, a RAM 403, and an HDD/SSD 404 that are connected to each other via a bus 400. The CPU 401 comprehensively controls operations of the mobile terminal 4 by executing a program stored in the ROM 402 or the HDD/SSD 404 using the RAM 403 as a work area, for example.

The mobile terminal 4 also includes a display unit 405, a camera unit 406, a microphone unit 407, a speaker unit 408, a wireless communication unit 409, an input/output I/F 410, a wireless LAN communication unit 411, and a BLE communication unit 412. The display unit 405 displays items, such as an operation menu and a processing state to the user. The camera unit 406 captures an image using a built-in camera, for example. The microphone unit 407 acquires sound using a built-in microphone, for example. The speaker unit 408 outputs sound. The wireless communication unit 409 performs audio communication or data communication. The input/output I/F 410 is an interface for inputting and outputting data to/from an external device, for example. The wireless LAN communication unit 411 communicates with other devices via a wireless LAN. The BLE communication unit 412 communicates with other devices by BLE.

The functions of the mobile terminal 4 described above with reference to FIG. 5 may be implemented by the CPU 401 executing a predetermined program, for example. The program may be acquired via a recording medium or via a network, or the program may be embedded in the ROM 402, for example. Note that the information stored in the mobile terminal as described above with reference to FIG. 5 may be temporarily stored in the RAM 403 and permanently stored in the HDD/SSD 404, for example.

[Operations]

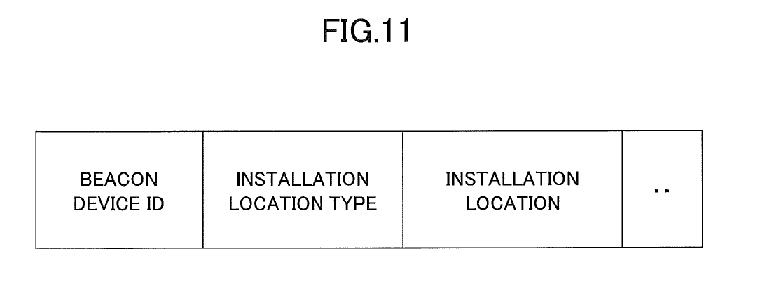

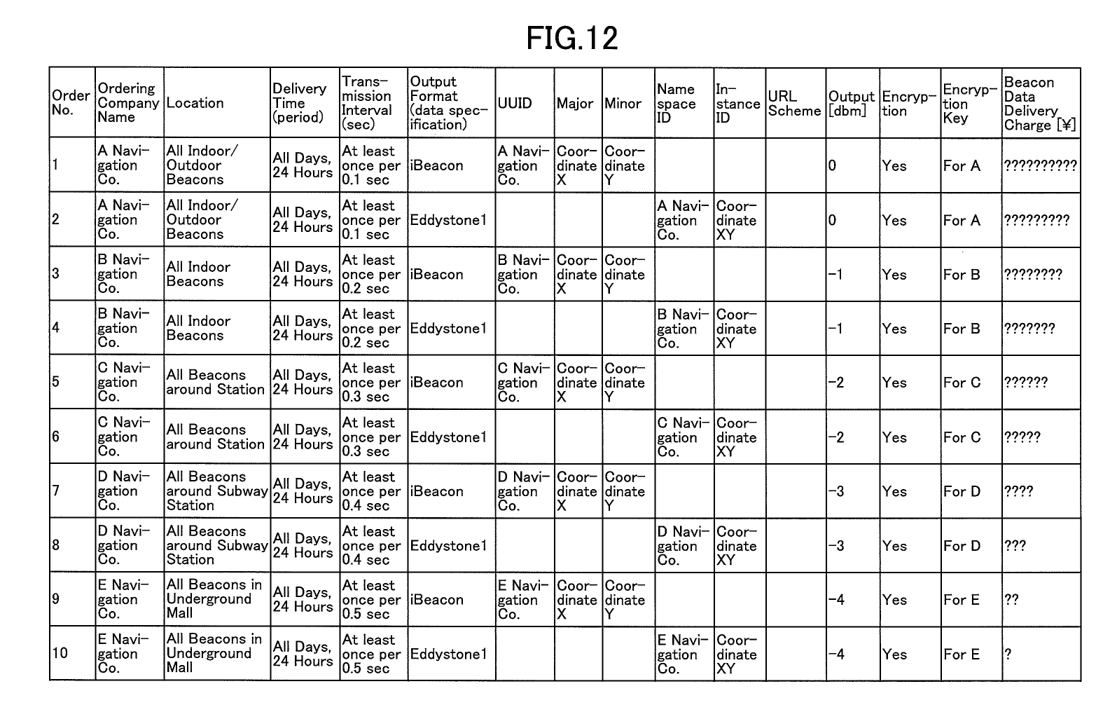

FIG. 10 is a sequence chart illustrating an example process according to the first embodiment. In FIG. 10, an operator of the beacon management server 5 performs a registration operation for registering beacon installation information in the beacon management server 5 at the time a beacon device 1 is first operated or at the time the beacon device 1 is newly installed (step S101). The information management unit 51 of the beacon management server 5 accepts the beacon installation information registration operation and registers the beacon installation information in the beacon installation information storage unit 52 (step S102). FIG. 11 is a diagram illustrating an example configuration of the beacon installation information. The beacon installation information of FIG. 11 includes information items, such “beacon device ID”, “installation location type”, and “installation location”. The “beacon device ID” is information identifying the beacon device 1. The “installation location type” is information indicating the type of location in which the beacon device 1 is installed. Examples of information that may be indicated as the “installation location type” include “indoors”, “outdoors”, “around station”, “around subway station”, “underground mall”, “at station”, “near XX hotel”, “near XX store”, “in XX bar”, and “in XX shop”. The “installation location” is information indicating the latitude, the longitude, and/or the address of the installation location, for example.

Referring back to FIG. 10, the operator of the beacon management server 5 performs a registration operation for registering beacon service information in the beacon management server 5 at the time beacon service orders are compiled (step S103). The information management unit 51 of the beacon management server 5 accepts the beacon service information registration operation and registers the beacon service information in the beacon service information storage unit 53 (step S104).

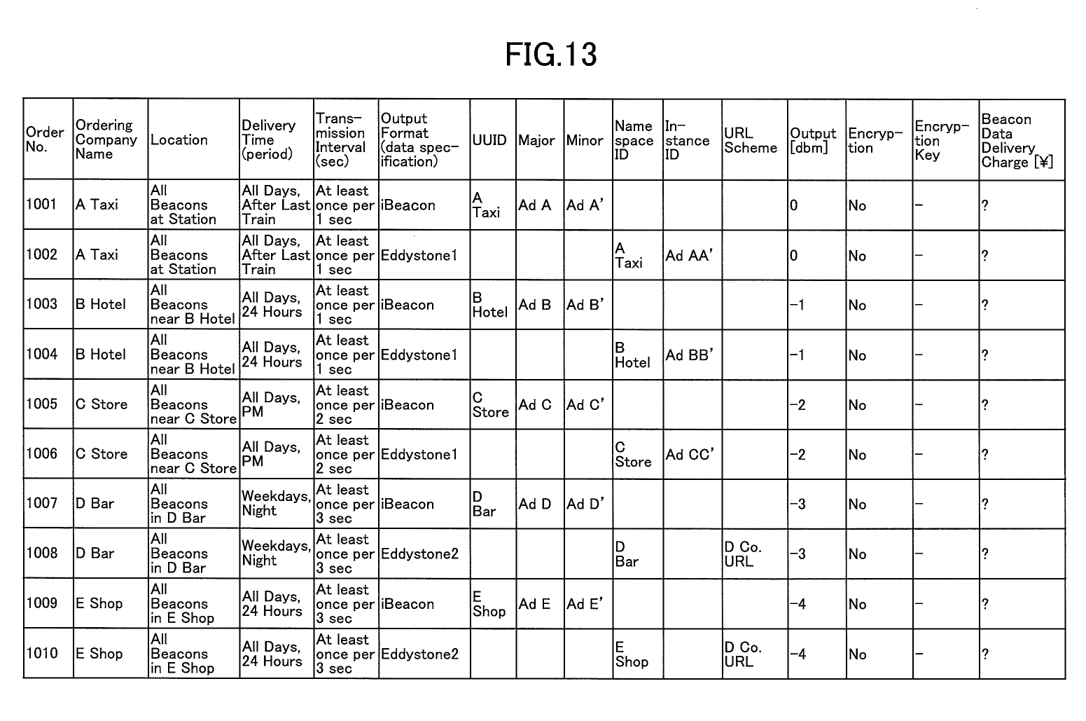

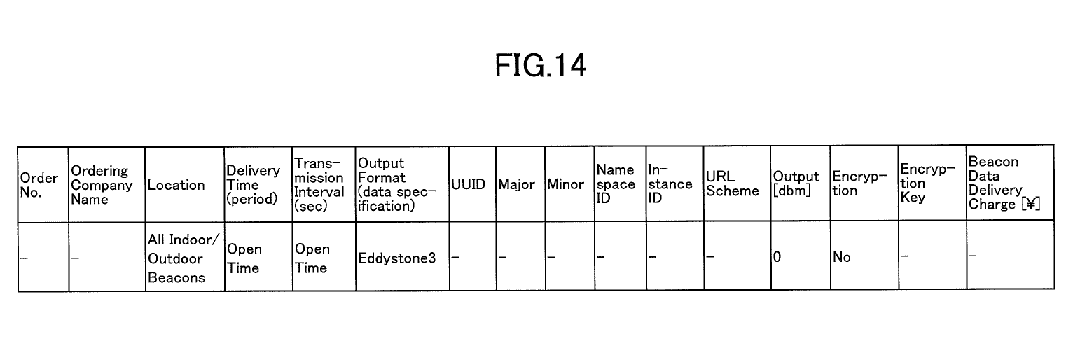

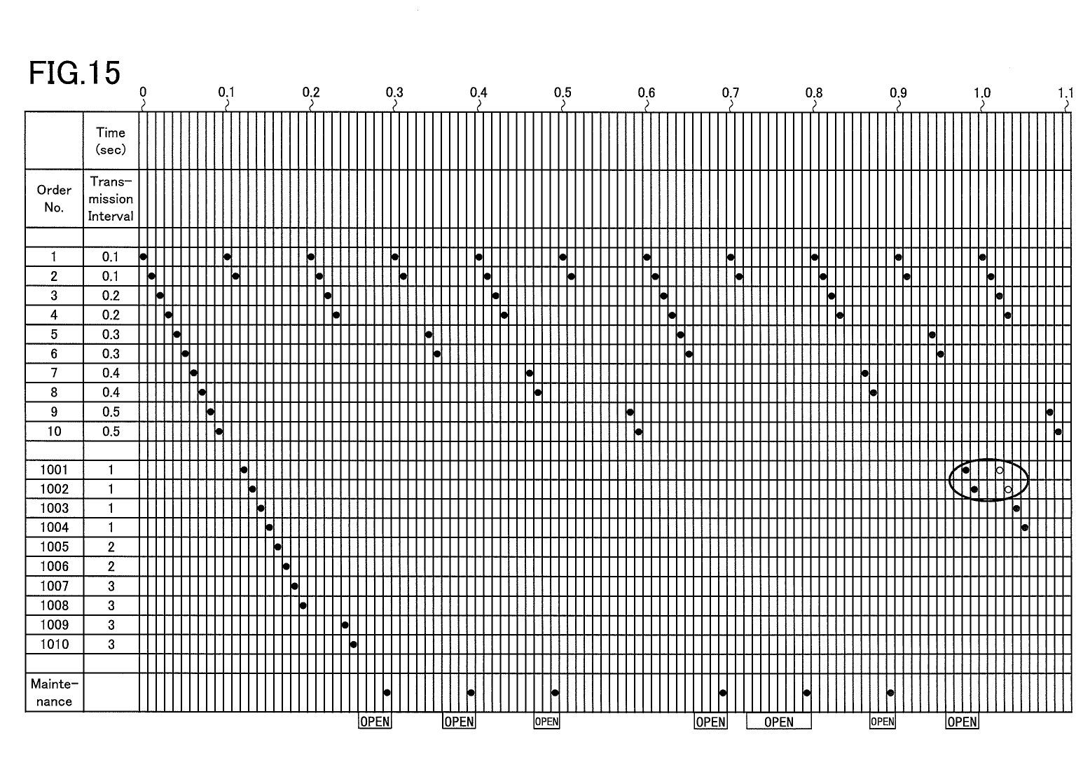

FIGS. 12 to 14 are diagrams illustrating examples of beacon service information. Note that the present example relates to a case where beacon signals are transmitted using BLE. FIG. 12 illustrates an example of beacon service information relating to a navigation service that is provided as a beacon service. FIG. 13 illustrates an example of beacon service information relating to an advertisement distribution service that is provided as a beacon service. FIG. 14 illustrates an example of beacon service information relating to maintenance for confirming whether beacon signals are being appropriately transmitted at the installation location of a beacon device 1. In FIGS. 12 to FIG. 14, the beacon service information includes information items, such as “Order No.”, “Ordering Company Name”, “Location”, “Delivery Time (period)”, “Transmission Interval (sec)”, “output format (data specification)”, “UUID”, “Major”, “Minor”, “Namespace ID”, “Instance ID”, “URL Scheme”, “Output [dbm]”, “Encryption”, “Encryption Key”, and “Beacon Data Delivery Charge [¥]”.

In FIG. 12, “Order No.” is a number for managing a beacon service order. Note that in the following, information items other than the “Order No.” are described with reference to a case where the “Order No.” is “1”. The “Order Company Name” indicates the name of the company that has ordered the beacon service for receiving a navigation service, such as “A Navigation Co.”. The “Location” indicates the location (range) of beacons to be used for transmitting data being ordered data, such as “All Indoor/Outdoor Beacons” (data transmission using all indoor and outdoor beacons being provided). The “Delivery Time (period)” indicates the time (period) for performing data transmission, such as “All Days, 24 Hours” (every day, 24 hours). The “Transmission Interval (sec)” indicates the interval of data transmission, such as “At least once per 0.1 sec” (at a minimum of 0.1-second intervals). Note that when data transmission is performed strictly at the specified transmission intervals, it may overlap with data transmission for another order number, and as such, the minimum transmission interval is specified as the transmission interval. The “Output Format (data specification)” indicates the format of data transmission, such as “iBeacon” (data transmission using iBeacon). Note that iBeacon is a standard for beacons using Apple's BLE advertising packet and includes ID information composed of three types of identifiers: proximityUUID, Major, and Minor (see e.g., “What is iBeacon”, http://smartphone-ec.net/ibeacon/system.html; “Physical layer of BLE”, https://blog.reinforce-lab.com/2013/02/06/ble-phy-layler/).

The “UUID” stands for Universally Unique Identifier and indicates a unique ID for identifying a company or organization, such as “A Navigation Co.”. The “Major” indicates the coordinate X, and the “Minor” indicates the coordinate Y. A unique ID for a beacon may be set up by the “Major” and “Minor”. The “Output [dbm]” indicates the output, such as “0” (0 dbm), set up at the time of data transmission. The “Encryption” indicates whether encryption is to be implemented in data transmission, such as “Yes” (encrypt). By implementing encryption, unauthorized use or spoofing of a beacon service may be prevented, for example. The “Encryption Key” indicates a key for decrypting data transmission, such as “For A” (dedicated encryption key for company A). The encryption key may be managed at the client side, such that data contained in a beacon signal may be kept secret for each client. The “Beacon Data Delivery Charge [¥]” indicates the beacon service charge for the ordering navigation service company, such as “????????” (relatively high for company A because of extensive beacon use location/time).

In the following, the beacon service information of FIG. 13 is described with reference to a case where the “Order No.” is “1002”. In FIG. 13, the “Ordering Company Name” indicates the company name, such as “A Taxi”, that is ordering a beacon service for a navigation service company. The “Location” indicates the location (range) of beacons used for data transmission of the ordered beacon service, such as “All Beacons at Station” (data transmission using all beacons at station). The “Delivery Time (period)” indicates the time (period) of data transmission, such as “All Days, After Last Train” (every day, from 23 o'clock to 24 o'clock, for example). The “Transmission Interval (sec)” indicates the interval of data transmission, such as “At least once time per 1 sec” (at one-second intervals at the minimum). Note that if data transmission is performed strictly at the specified transmission interval, it may overlap with data transmission of another order number, and as such, the minimum transmission interval is indicated as the transmission interval. The “Output Format (data specification)” indicates the format of data transmission, such as “Eddystone 1” (data transmission using Eddystone 1). Eddystone is a standard for beacons using BLE advertising packets developed by Google Inc. Eddystone contains three frame types including Eddystone 1, which is the frame closest to iBeacon, Eddystone 2, which incorporates the concept of UrlBeacon, and Eddystone 3, which is a frame for sending the state of Eddystone. Eddystone 1 specifies a “Namespace ID” corresponding to the “UUID” of iBeacon and an “Instance ID” corresponding to the “Major” and “Minor” of iBeacon (see e.g., “What is Google Eddystone”, http://dev.classmethod.jp/smartphone/eddystone/).

The “Namespace ID” is a unique ID for identifying a company or organization, such as “A taxi” (ID for A taxi). The “Instance ID” uniquely identifies a specific beacon, such as “Ad AA′” (display of advertisement AA′). The “Output [dbm]” indicates the output, such as “0” (0 dbm), set at the time of data transmission. The “Encryption” indicates whether encryption is to be implemented in data transmission, such as “No” (no encryption). The “Beacon Data Delivery Charge [¥]” indicates the beacon service charge for the ordered advertisement distribution service, such as “?” (relatively low for A taxi because of small beacon use location/time).

In the beacon service information for maintenance illustrated in FIG. 14, the “Location” is indicated as “All Indoor/Outdoor Beacons”, the “Delivery Time (period)” and the “Transmission Interval (sec)” is indicated as “Open Time”, the “Output Format (data specification)” is indicated as “Eddystone 3”, the “Output [dbm]” is indicated as “0”, and the “Encryption” is indicated as “No”. The beacon management server 5 performs maintenance communication with each beacon device 1 as appropriate to determine the operation state of each beacon device 1. A beacon signal transmitted based on this information may be used for on-site maintenance purposes to determine whether the beacon signal is actually transmitted to the site, for example. In the present example, it is assumed that a beacon signal for on-site maintenance is transmitted in the output format “Eddystone 3” regardless of the output formats used by the ordering companies. Also, the beacon signal for on-site maintenance is transmitted at an open time when data transmission according to FIG. 12 and FIG. 13 is not scheduled or is relatively sparse. By transmitting a beacon signal for on-site maintenance at an open time, on-site maintenance can be performed in real time during beacon signal transmission operations, for example. Also, by unifying the beacon signal specification (data) for on-site maintenance regardless of the specifications for data transmission relating to other beacons service orders, maintenance may be facilitated, for example.

Referring back to FIG. 10, the beacon-specific information generation unit 54 of the beacon management server 5 extracts a transmission format and transmission data of each service from the beacon service information for each beacon device 1 at a predetermined timing, generates a transmission timing (scheduling), and registers the generated transmission timing in the beacon-specific information storage unit 55 (step S105). That is, by referring to the “location” of the beacon service information (FIG. 12 to FIG. 14) and the beacon installation information (FIG. 11) of each beacon device 1, the beacon-specific information generation unit 54 identifies the “order number” of a relevant service for each beacon device 1. Then, the beacon-specific information generation unit 54 extracts the transmission format and the transmission data from the beacon service information, and generates the transmission timing by performing transmission scheduling. As for the transmission format, the beacon-specific information generation unit 54 may extract the “Output Format (data specification)” of the beacon service information, for example. As for the transmission data, the beacon-specific information generation unit 54 may extract the “UUID”, “Major”, “Minor”, “Namespace ID”, “Instance ID”, “URL Scheme”, and/or the “Output [dbm]”, for example.

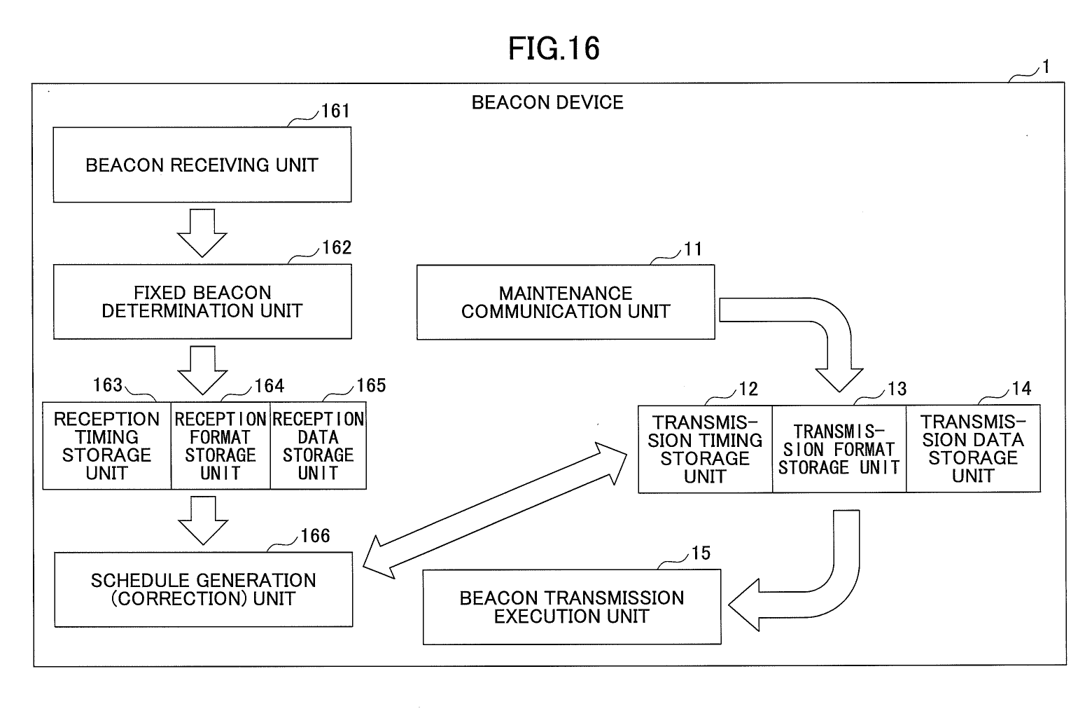

FIG. 15 is a diagram illustrating example transmission timings. FIG. 15 illustrates an example case of sequentially transmitting data for all the ordered services illustrated in FIGS. 12 to 14. The black circles indicate the timings at which beacon signals are to be transmitted. In this example, the data transmission capability of the beacon signal is 100 data per second (1 data per 10 mS).

Also, note that in FIG. 15, the transmission timings are adjusted at a circled portion around time “1.0”. That is, if scheduling is performed only based on the transmission intervals specified by the beacons signal specifications of the beacon services, transmission timings will overlap. For example, if data transmission for orders No. 1001 and 1002 (with transmission intervals at 1 sec) are carried out at time points indicated by the white circles in FIG. 15, the data transmissions would be performed at 1-second intervals as specified. However, in such case, the data transmissions will overlap with the data transmissions for order Nos. 3 and 4 (with transmission intervals of 0.2 sec). Accordingly, in the present example, the transmission timings with the shorter transmission intervals (order Nos. 3 and 4) are prioritized, and the data transmissions for the order Nos. 1001 and 1002 are performed at time points represented by black circles that are shifted forward from the white circles in FIG. 15. By performing the data transmission at an “open” time at which no other transmission is scheduled in FIG. 15 corresponding to a vacant time before the originally scheduled transmission timings, the minimum transmission interval can be maintained. Note that in some embodiments, the data transmissions may be performed after the originally scheduled transmission timings. In this way, the minimum transmission intervals may be substantially maintained and beacon signals may be transmitted at relatively accurate transmission intervals at the beacon device 1. Also, the transmission timings of beacon signals for maintenance as illustrated in FIG. 14 may be scheduled such that transmissions are executed at open times, such as times 0.29, 0.39, 0.49, and so on, for example.

Referring back to FIG. 10, when the beacon-specific information is registered in the beacon-specific information storage unit 55 by the beacon-specific information generation unit 54, the maintenance communication unit 56 takes into account the past maintenance results of the maintenance result storage unit 57, and transmits to each beacon device, the transmission format, the transmission data, and the transmission timing for each service (step S106). Note that taking into account past maintenance results means determining the data that has been transmitted to a beacon device 1 so far and transmitting data based thereon, for example.

Upon receiving the transmission format, the transmission data, and the transmission timing for each service from the beacon management server 5, the maintenance communication unit 11 of the beacon device 1 sets up the received transmission format, transmission data and transmission timing in the transmission timing storage unit 12, the transmission format storage unit 13, and the transmission data storage unit 14 (step S107). Also, the maintenance communication unit 11 may send a response to the beacon management server 5 as necessary to indicate whether data registration has been successfully performed, for example (step S108).

The maintenance communication unit 56 of the beacon management server 5 registers information specifying the data set up for each beacon device 1 as a maintenance result in the maintenance result storage unit 57 (step S109).

Then, in subsequent operations, the beacon transmission execution unit 15 of the beacon device 1 sequentially transmits the transmission data registered in the transmission data storage unit 14 as beacon signals to the surroundings, in the transmission format registered in the transmission format storage unit 13, based on the transmission timing registered in the transmission timing storage unit 12 (step S110).

When a mobile terminal 4 located in the vicinity of the beacon device 1 receives the beacon signal (step S111), if the beacon device 1 is registered in advance in the mobile terminal 4, the mobile terminal 4 extracts the data included in the beacon signal and passes the extracted data to the beacon utilizing application 42 (step S112).

Then, the beacon utilizing application 42 sends a request for content to a corresponding content server 3 (step S113), and the content server 3 responds by transmitting the requested content to the mobile terminal 4 (step S114).

For example, with respect to order No. 1 corresponding to a beacon service order for a navigation service as illustrated in FIG. 12, it may be assumed that the beacon utilizing application 42 created by A Navigation Co. is installed and run on the mobile terminal 4. In such case, when the mobile terminal 4 acquires the UUID from the beacon signal, the mobile terminal 4 may use the UUID of the beacon device 1 (A Navigation Co.) and the encrypted Major (coordinate X) and Minor (coordinate Y) of the beacon device 1 to send an inquiry (request) to the content server 3 of the A Navigation Co. about position coordinates of the beacon device 1. The content server 3 may decrypt the received Major (coordinate X) and Minor (coordinate Y) using the encryption key for Company A to identify the beacon device 1 and send a response including the position coordinates of the beacon device 1 to the mobile terminal 4. The mobile terminal 4 may then display its current position on a map based on the received position coordinates.

Also, with respect to order No. 2002 corresponding to a beacon service order for an advertisement delivery service as illustrated in FIG. 13, it may be assumed that the beacon utilizing application 42 created by A Taxi is installed and run on the mobile terminal 4 (e.g., in the background). In such case, when the mobile terminal 4 acquires a Namespace ID (A Taxi) from a beacon signal received from a beacon device 1, the mobile terminal 4 can specify the beacon device 1 based on the Instance ID and send an inquiry to the content server 3 of A Taxi using the Instance ID. Based on the Instance ID received from the mobile terminal 4, the content server 3 may return a discount coupon or the like to the mobile terminal 4 based on the location of the beacon device 1 and use history of A Taxi by the user of the mobile terminal 4, for example. In turn, the mobile terminal 4 may display the received discount coupon, for example.

### Second Embodiment

According to a second embodiment of the present invention, the beacon device 1 further implements a function of reducing influences of interference caused by beacons coming from outside. Note that the system configuration according to the second embodiment may be substantially similar to that of the first embodiment as illustrated in FIG. 1, and the functional configurations of the content server 3, the mobile terminal 4, and the beacon management server 5 according to the second embodiment may be substantially similar to those of the first embodiment as illustrated in FIGS. 4 to 6. Also, the hardware configurations of the beacon device 1, the content server 3, the mobile terminal 4, and the beacon management server 5 according to the second embodiment may be substantially similar to those of the first embodiment as illustrated in FIGS. 7 to 9.

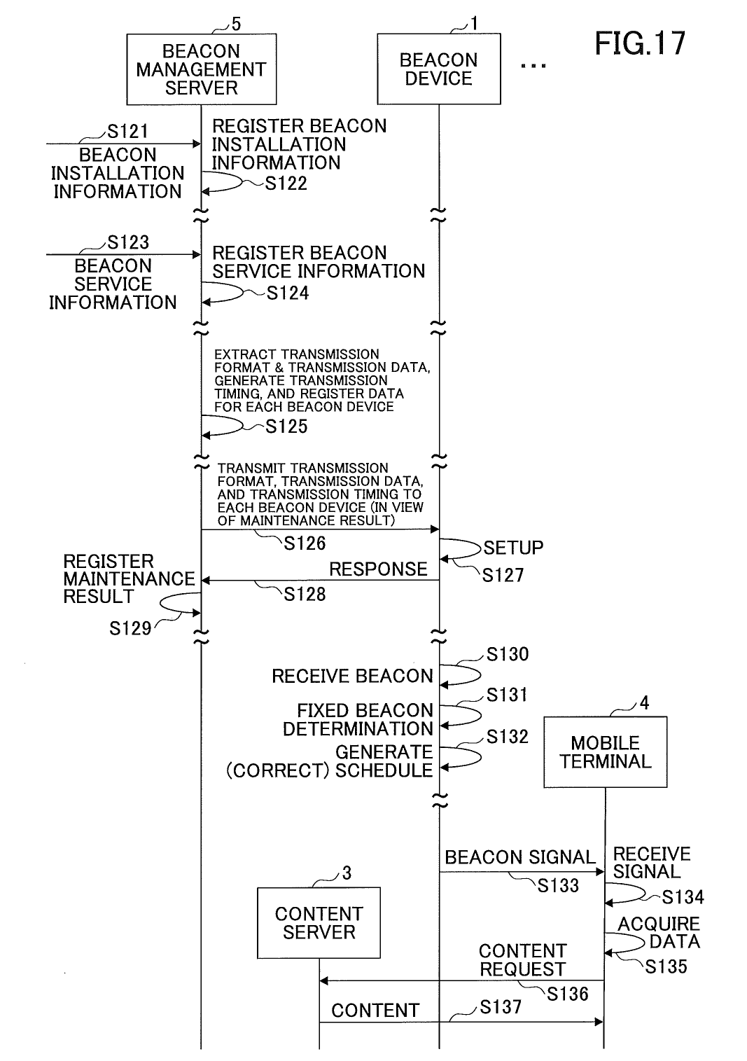

FIG. 16 is a diagram illustrating an example functional configuration of the beacon device 1 according to the second embodiment. In FIG. 16, the beacon device 1 includes the maintenance communication unit 11, the beacon transmission execution unit 15, a beacon receiving unit 161, a fixed beacon determination unit 162, and a schedule generation (correction) unit 166.

The maintenance communication unit 11 receives transmission timings, transmission formats, and transmission data of a plurality of beacon signal specifications corresponding to a plurality of beacon services from the beacon management server 5 at a predetermined timing, and registers the received transmission timings, transmission formats, and transmission data in the transmission timing storage unit 12, the transmission format storage unit 13, and the transmission data storage unit 14. The transmission timing storage unit 12, the transmission format storage unit 13, and the transmission data storage unit 14 associates a beacon signal specification with corresponding transmission timing, transmission format, and transmission data for each beacon service. The associated information may be stored in one table or in a plurality of tables, for example.

The beacon receiving unit 161 receives a beacon coming from the outside and acquires a reception timing, a reception format, and reception data of the received beacon. The fixed beacon determination unit 162 determines whether the received beacon has been transmitted from a fixed station. If it is determined that the received beacon has been transmitted from a fixed station, the fixed beacon determination unit 162 registers the reception timing, the reception format, and the reception data of the received beacon as interference information in a reception timing storage unit 163, a reception format storage unit 164, and a reception data storage unit 165. Note that even if a beacon transmitted from a mobile station accidentally interferes with transmission operations within the system, the interference would not occur on a continual basis, and as such, only a beacon transmitted from a fixed station is subjected to further processing in the present embodiment.

To determine whether a received beacon has been transmitted from a fixed station, for example, the fixed beacon determination unit 162 may calculate the distance between the beacon device 1 and the transmission source based on the received signal strength (RSSI: Received Signal Strength Indicator) of the beacon received by the beacon reception unit 161, monitor a change in the calculated distance over a predetermined time period, and determine that the transmission source corresponds to a fixed station if the change the calculated distance does not exceed a predetermined threshold. The RSSI becomes a smaller value as the distance between the beacon device 1 and the beacon transmission source increases. Assuming “r” represents the distance, “A” represents the RSSI measured when the distance r is around 1 m, and “B” represents a constant indicating the degree of radio wave attenuation (theoretically “2”), the RSSI may be expressed by the following equation.

RSSI(r)=A−10B log₁₀(r)

Based on the above equation, the distance r may be calculated using the following equation.

r=10^{(A-RSSI)/10B}

The schedule generation unit 166 refers to the reception timing storage unit 163 and the reception format storage unit 164 at a predetermined timing and corrects (finalizes) the schedule that has already been received from the beacon management server 5 and registered in the transmission timing storage unit 12 and the transmission format storage unit 13, for example.

The beacon transmission execution unit 15 transmits, for each beacon service, transmission data registered in the transmission data storage unit 14 as a beacon signal to the surroundings, in the transmission format registered in the transmission format storage unit 13, based on the transmission timing registered in the transmission timing storage unit 12.

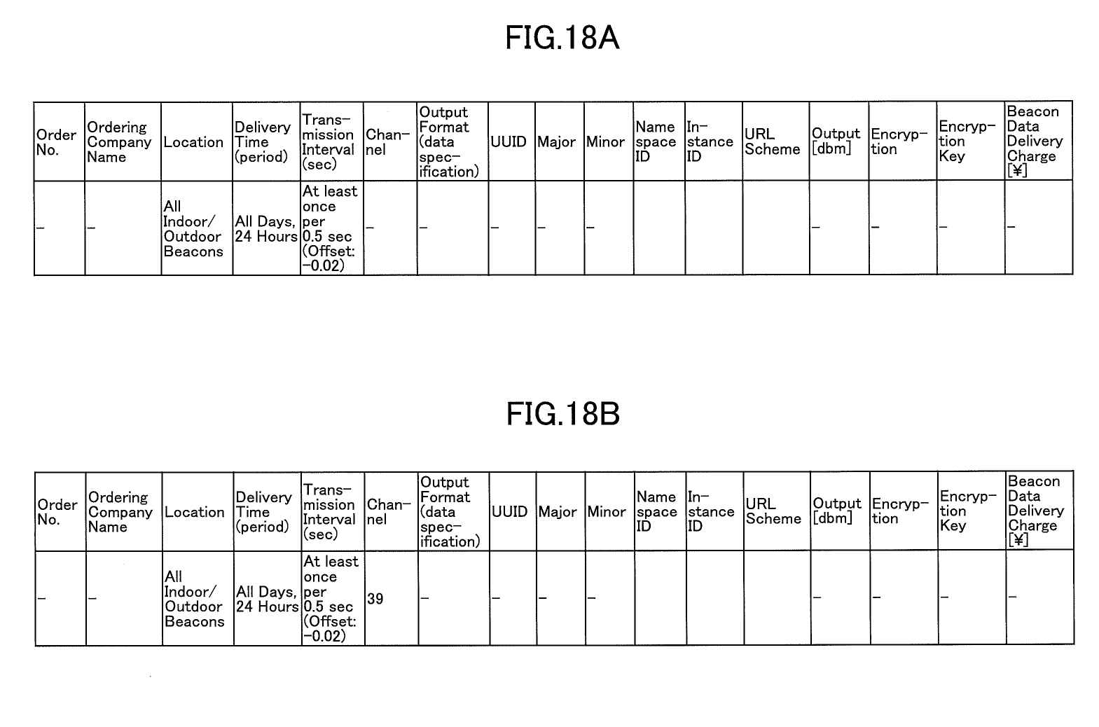

FIG. 17 is a sequence chart illustrating an example process according to the second embodiment. In FIG. 17, the operator of the beacon management server 5 performs a registration operation for registering beacon installation information in the beacon management server 5 at the initial operation time of a beacon device 1 or at the time a beacon device 1 is newly installed (step S121). The information management unit 51 of the beacon management server 5 accepts the beacon installation information registration operation and registers the beacon installation information in the beacon installation information storage unit 52 (step S122). Note that the configuration of the beacon installation information may be substantially identical to that illustrated in FIG. 11, for example.

Referring back to FIG. 17, the operator of the beacon management server 5 registers the beacon service information in the beacon management server 5 at the time of compiling beacon service orders (step S123). The information management unit 51 of the beacon management server 5 accepts the beacon service information registration operation and registers the beacon service information in the beacon service information storage unit 53 (step S124). Note that the beacon service information may be substantially identical to that illustrated in FIGS. 12 to 14, for example.

Referring back to FIG. 17, the beacon-specific information generation unit 54 of the beacon management server 5 extracts the transmission format and transmission data of each service from the beacon service information for each beacon device 1 at a predetermined timing, generates a corresponding transmission timing (scheduling), and registers the generated transmission timing in the beacon-specific information storage unit 55 (step S125). The transmission timing may be the same as that illustrated in FIG. 15, for example.

Referring back to FIG. 17, when the beacon-specific information is registered in the beacon-specific information storage unit 55 by the beacon-specific information generation unit 54, the maintenance communication unit 56 takes into account past maintenance results of the maintenance result storage unit 57 and transmits to each beacon device 1, corresponding transmission format, transmission data, and transmission timing for each service (step S126). Note that taking into account past maintenance results means determining the data that has been transmitted to a relevant beacon device 1 so far based on past maintenance results and transmitting data to the relevant beacon device 1 based thereon, for example.

When maintenance communication unit 11 of the beacon device 1 receives the transmission format, transmission data and transmission timing for each service from the beacon management server 5, the maintenance communication unit 11 of the beacon device 1 registers the received transmission format, transmission data and transmission timing in the transmission timing storage unit 12, the transmission format storage unit 13, and the transmission data storage unit 14 (step S127). Also, the maintenance communication unit 11 sends a response to the beacon management server 5 as necessary to indicate whether the received information has been successfully registered, for example (step S128). Then, the maintenance communication unit 56 of the beacon management server 5 registers information specifying the data that has been set up in each beacon device 1 as a maintenance result in the maintenance result storage unit 57 (step S129).

Meanwhile, in parallel with the above process, the beacon receiving unit 161 of the beacon device 1 receives a beacon coming from the outside and acquires a reception timing, a reception format, and reception data of the received beacon (step S130). Then, the fixed beacon determination unit 162 determines whether the received beacon has been transmitted from a fixed station. If it is determined that the received beacon has been transmitted from a fixed station, the fixed beacon determination unit 162 registers the reception timing, the reception format, and the reception data of the received beacon as interference information in the reception timing storage unit 163, the reception format storage unit 164, and the reception data storage unit 165 (step S131). Note that because the reception timing of a beacon coming from the outside may vary depending on the accuracy of the transmitting external device, basically, the latest information on the reception timing is treated as valid information.

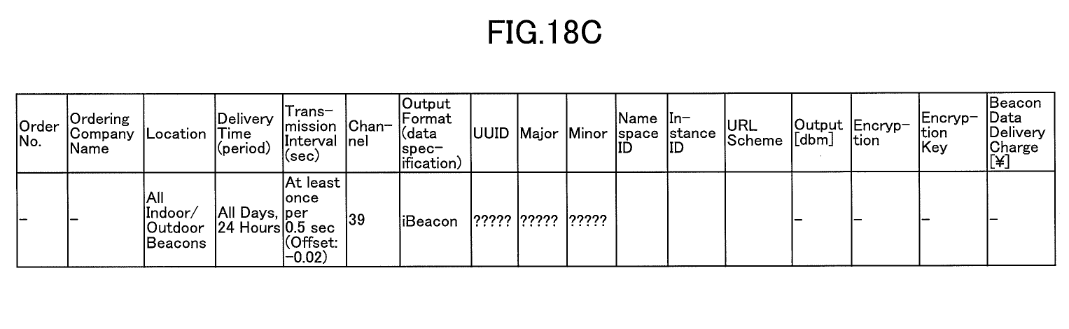

FIGS. 18A-18C are diagrams illustrating examples of interference information. Note that for the sake of clarity, the interference information illustrated in FIGS. 18A-18C are in the same format as the beacon service information illustrated in FIGS. 12 to 14. However, information items corresponding to the reception timing, the reception format, and reception data can be stored in any arbitrary format. Also, in FIGS. 18A-18C, an information item “Channel” is added to the information items of the beacon service information illustrated in FIGS. 12 to 14. However, the information item “Channel” may also be included in the beacon service information illustrated in FIGS. 12 to 14.

FIG. 18A illustrates an example case where beacons transmitted at a transmission interval of 0.5 seconds and an offset of −0.02 seconds (i.e., transmission occurring at 0.48 seconds, 0.98 seconds, . . . ) are received. FIG. 18B illustrates an example case where the transmission interval and the offset of the beacons are the same as in FIG. 18A, and a channel is also specified. FIG. 18C illustrates an example case where the transmission interval, the offset, and the channel are the same as in FIG. 18B, and an output format is further specified. Note that the output format “iBeacon” is usually used for transmitting beacons from a fixed station.

Referring back to FIG. 17, the schedule generation unit 166 refers to the reception timing storage unit 163 and the reception format storage unit 164 at a predetermined timing, and corrects (finalizes) the transmission timing (schedule) that has already been received from the beacon management server 5 and registered in the transmission timing storage unit 12 (step S132).

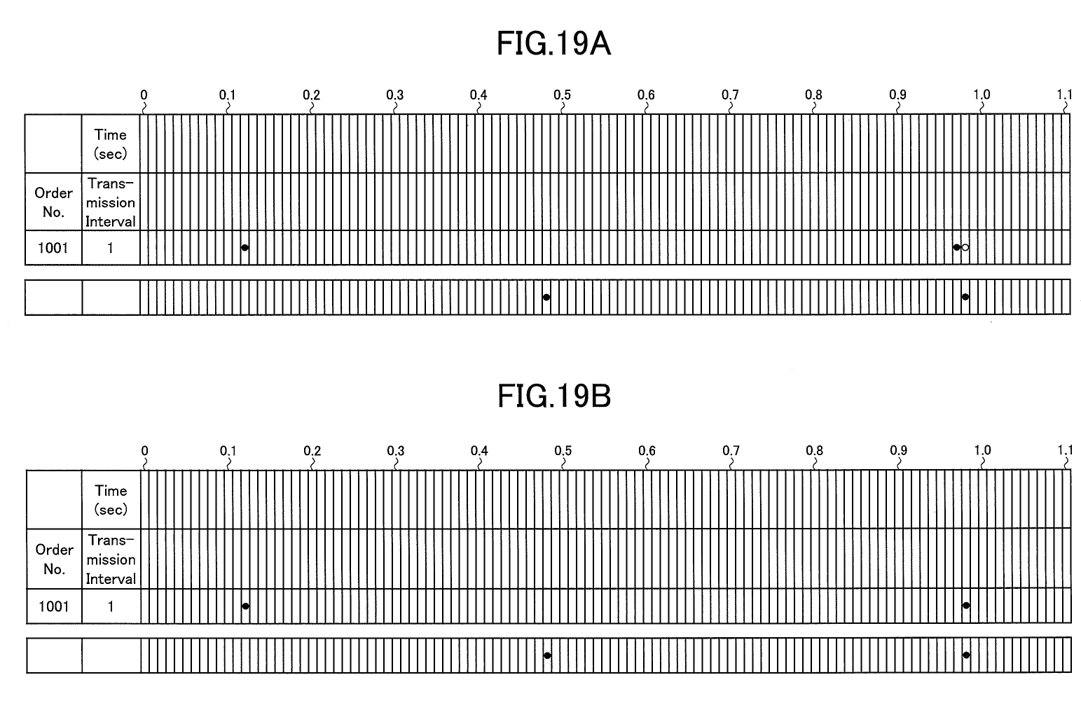

In FIG. 19A, transmission timings for the beacon service with the order No. 1001 extracted from the transmission timings of FIG. 15 and the interference timings of beacons illustrated in FIG. 18A are indicated next to each other. In this example, beacon transmission for the beacon service with the order No. 1001 is preliminarily scheduled at a position indicated by a white circle, at time 0.98, which overlaps with the reception timing of the beacon from the outside. As such, adverse effects due to interference may occur. Thus, the schedule generation unit 166 corrects the transmission timing from the position of the white circle to the position of a black circle located immediately before the white circle at which no overlap occurs with transmission for another beacon service order.

In FIG. 19B, transmission timings for the beacon service with the order No. 1001 extracted from the transmission timings of FIG. 15 and the interference timings of beacons illustrated in FIG. 18B or 18C are indicated next to each other. In this example, beacon transmission for the beacon service with the order No. 1001 is preliminarily scheduled at a position indicated by a black circle, at time 0.98, which overlaps with the reception timing of the beacon from the outside. As such, adverse effects due to interference may occur. However, in FIG. 18B or 18C, the transmission of the beacon from the outside is performed using the channel “39”. Thus, if another channel, such as channel “37”, can be used to perform beacon transmission, the other available channel may be designated and correction of the transmission timing for the beacon service with the order No. 1001 may be unnecessary.

Referring back to FIG. 17, in subsequent operations, the beacon transmission execution unit 15 of the beacon device 1 sequentially transmits the transmission data registered in the transmission data storage unit 14 as beacon signals to the surroundings, in the transmission format registered in the transmission format storage unit 13, based on the transmission timing (which may be corrected) registered in the transmission timing storage unit 12 (step S133).

When a mobile terminal 4 located in the vicinity of the beacon device 1 receives the beacon signal (step S134), if the beacon device 1 registered in advance in the mobile terminal 4, the mobile terminal 4 extracts the data included in the beacon signal and passes the extracted data to the beacon utilizing application 42 (step S135).

Then, the beacon utilizing application 42 sends a request for content to a corresponding content server 3 (step S136), and the content server 3 sends a response including the requested content to the mobile terminal 4 (step S137).

According to an aspect of the present embodiment, a schedule (transmission timing) can be corrected in real time in the beacon device 1 that receives a beacon from the outside which may cause interference, and in this way, adverse effects of interference may be avoided. Note that the transmission timing of beacons from the outside may fluctuate depending on the accuracy of the transmitting external device, and when such fluctuation occurs, correction of the schedule may have to be re-executed. Nonetheless, by enabling real-time correction of a schedule in the beacon device 1 according to the present embodiment, convenience may be improved.

### Third Embodiment

In the above-described second embodiment, the finalization (correction) of the beacon transmission timing is performed at the beacon device 1. On the other hand, according to a third embodiment of the present invention, interference information is transmitted from the beacon device 1 to the beacon management server 5, and correction of a beacon transmission timing is performed at the beacon management server 5. Note that the system configuration according to the present embodiment may be substantially similar to that illustrated in FIG. 1, and the functional configurations of the content server 3 and the mobile terminal 4 may be substantially similar to those illustrated in FIGS. 4 and 5. Also, the hardware configurations of the beacon device 1, the content server 3, the mobile terminal 4, and the beacon management server 5 may be substantially similar to those illustrated in FIGS. 7 to 9.

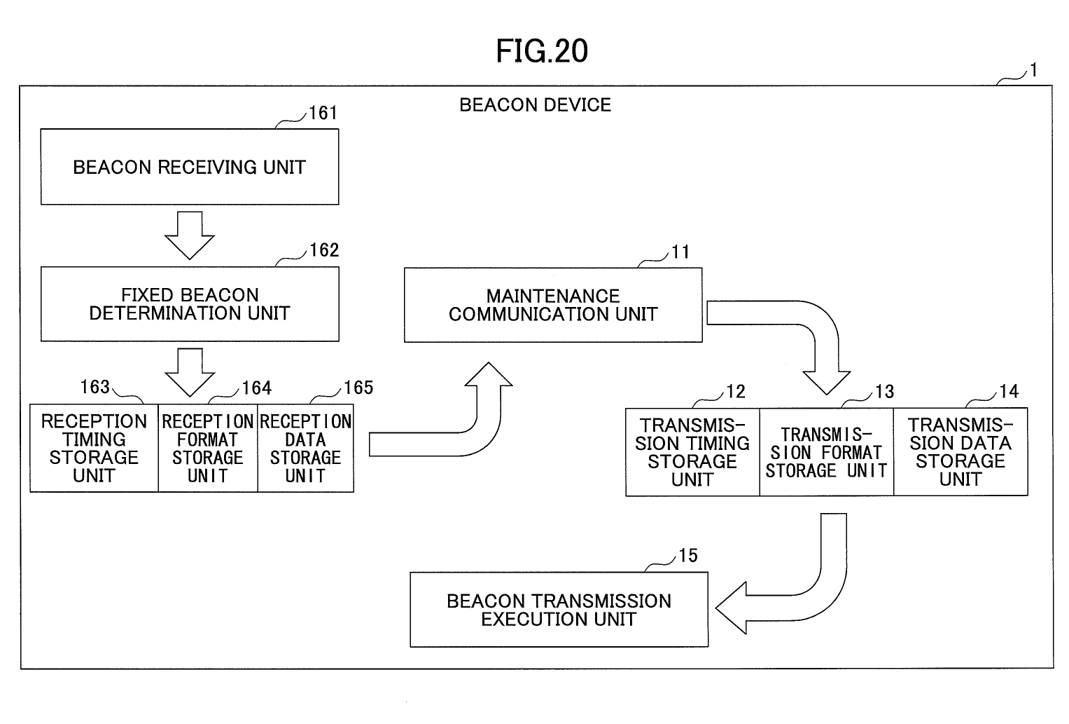

FIG. 20 is a diagram illustrating an example functional configuration of the beacon device 1 according to the third embodiment. In FIG. 20, the beacon device 1 includes the maintenance communication unit 11, the beacon transmission execution unit 15, the beacon receiving unit 161, and the fixed beacon determination unit 162.

The maintenance communication unit 11 transmits interference information acquired by the beacon device 1 to the beacon management server 5, and receives, at a predetermined timing. The maintenance communication unit 11 also receives transmission timings, transmission formats, and transmission data of a plurality of beacon signal specifications corresponding to a plurality of beacon services from the beacon management server 5 at a predetermined timing, and registers the received information in the transmission timing storage unit 12, the transmission format storage unit 13, and the transmission data storage unit 14.

The beacon receiving unit 161 receives a beacon coming from the outside and acquires the reception timing, reception format, and reception data of the received beacon. The fixed beacon determination unit 162 determines whether the received beacon has been transmitted from a fixed station. If it is determined that the received beacon has been transmitted from a fixed station, the fixed beacon determination unit 162 registers the reception timing, the reception format, and the reception data of the received beacon as interference information in the reception timing storage unit 163, reception format storage unit 164, and the reception data storage unit 165.

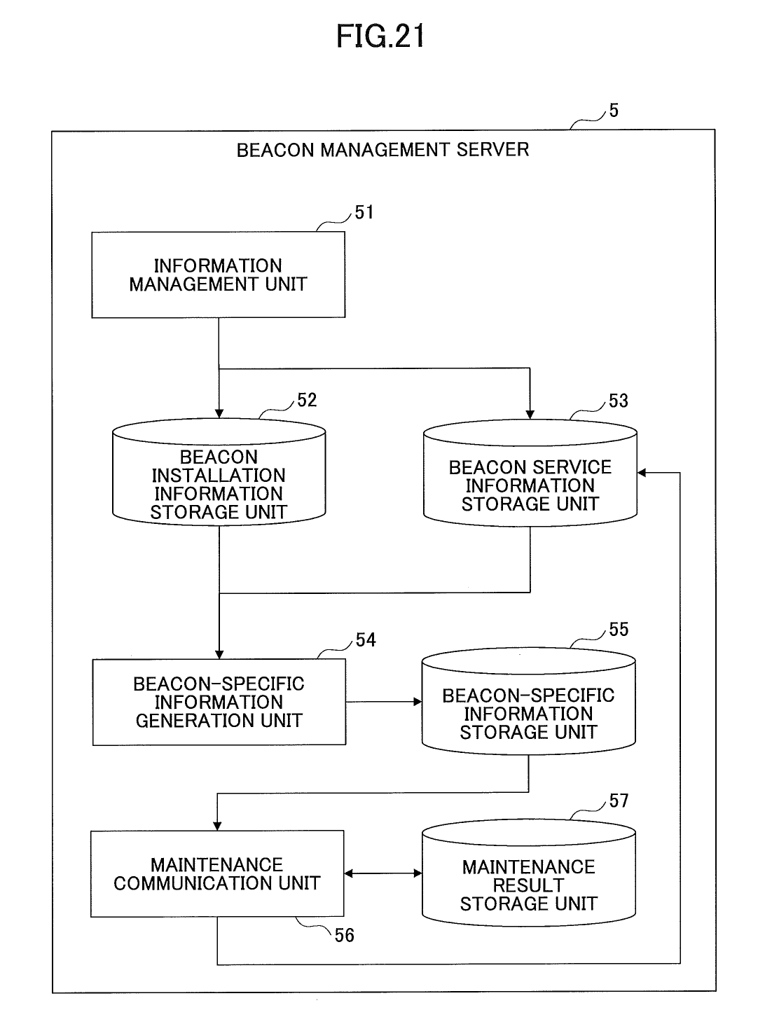

FIG. 21 is a diagram illustrating an example functional configuration of the beacon management server 5 according to the third embodiment. In FIG. 21, the beacon management server 5 includes the information management unit 51, the beacon-specific information generation unit 54, and the maintenance communication unit 56. The information management unit 51 registers beacon installation information including the installation position of the beacon device 1 that is being managed by the beacon management server 5 in the beacon installation information storage unit 52 and also registers detailed information (beacon service information) of a beacon service order in the beacon service information storage unit 53. In the present embodiment, interference information received from the beacon device 1 is also registered in the beacon service information storage unit 53.

The beacon-specific information generation unit 54 generates setting information (beacon-specific information) for each beacon device 1; based on the beacon installation information registered in the beacon installation information storage unit 52 and the beacon service information (including interference information) registered in the beacon service information storage unit 53, and registers the generated beacon-specific information in the beacon-specific information storage unit 55. The maintenance communication unit 56 receives interference information from the beacon device 1 and registers the received interference information in the beacon service information storage unit 53. The maintenance communication unit 56 also performs maintenance communication with the beacon device 1 to set up the beacon device 1 based on the beacon-specific information registered in the beacon-specific information storage unit 55. Further, the maintenance communication unit 56 registers a result of the maintenance communication in the maintenance result storage unit 57.

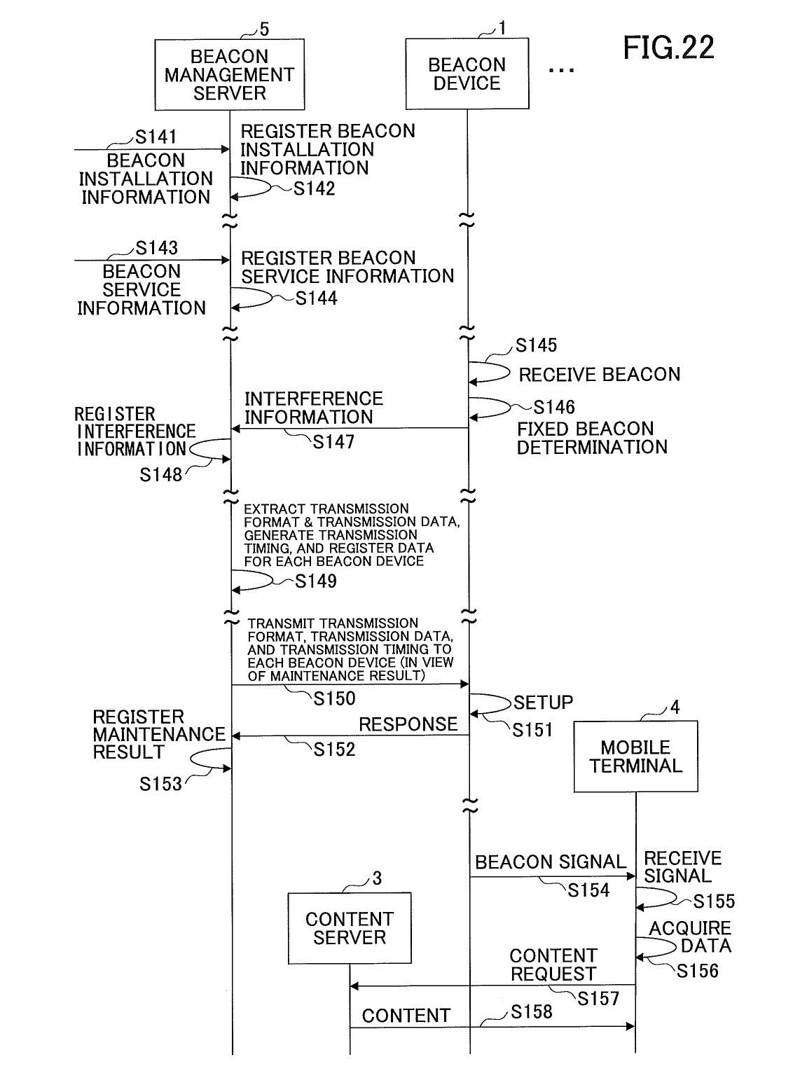

FIG. 22 is a sequence chart illustrating an example process according to the third embodiment. In FIG. 22, the operator of the beacon management server 5 performs a registration operation for registering beacon installation information in the beacon management server 5 at the initial time of operating a beacon device or at the time the beacon device 1 is newly installed (step S141). The information management unit 51 of the beacon management server 5 receives the beacon installation information registration operation'and registers the beacon installation information in the beacon installation information storage unit 52 (step S142). Note that the beacon installation information registered in step S142 may have a configuration substantially similar to that illustrated in FIG. 11, for example.

Referring back to FIG. 22, the operator of the beacon management server 5 performs a registration operation for registering beacon service information in the beacon management server 5 at the time of compiling beacon service orders (step S143). The information management unit 51 of the beacon management server 5 accepts the beacon service information registration operation and registers the beacon service information in the beacon service information storage unit 53 (step S144). Note that the beacon service information registered in step S144 may be substantially similar to that illustrated in FIGS. 12 to 14, for example. Also, the interference information that is also registered in the present embodiment may have a format substantially similar to that illustrated in FIGS. 18A-18C, for example.

Referring back to FIG. 22, the beacon receiving unit 161 of the beacon device 1 receives a beacon coming from the outside, and acquires the reception timing, the reception format, and the reception data of the received beacon (step S145). Then, the fixed beacon determination unit 162 determines whether the received beacon has been transmitted from a fixed station. If it is determined that the received beacon has been transmitted from a fixed station, the fixed beacon determination unit 162 registers the reception timing, the reception format, and the reception data of the received beacon as interference information in the reception timing storage unit 163, the reception format storage unit 164, and the reception data storage unit 165 (step S146). Then, the maintenance communication unit 11 transmits the registered reception timing, reception format, and reception data to the beacon management server 5 as interference information (step S147). The maintenance communication unit 56 of the beacon management server 5 registers the received interference information in the beacon service information storage unit 53 (step S148).

The beacon-specific information generation unit 54 of the beacon management server 5 extracts the transmission format and the transmission data for each service from the beacon service information for each beacon device 1 at a predetermined timing, generates (schedules) a transmission timing for each service, and transmits the generated transmission timing in the beacon-specific information storage unit 55 (step S149). In generating the transmission timing, beacon-specific information generation unit 54 sets up the transmission timing so that it does not overlap with the reception timing of a beacon coming from the outside that may be an interference as illustrated in FIG. 19A, or the beacon-specific information generation unit 54 may specify a channel to be used in the case where influences of interference can be avoided by adjusting the channel as illustrated in FIG. 19B. Note that in scheduling transmission with respect to a beacon device 1, the beacon-specific information generation unit 54 may take into account the interference information received from the beacon device 1 that is subjected to scheduling. The beacon-specific information generation unit 54 may also take into account interference information received from other beacon devices 1 located close to the beacon device 1 subjected to scheduling based on the information on the installation location (FIG. 11) of the beacon devices. In this way, the transmission timing for each service similar to that illustrated in FIG. 15 may be generated.

Referring back to FIG. 22, when the beacon-specific information is registered in the beacon-specific information storage unit 55 by the beacon-specific information generation unit 54, the maintenance communication unit 56 takes into account past maintenance results registered in the maintenance result storage unit 57, and transmits the transmission format, the transmission data, and the transmission timing for each service to each beacon device 1 (step S150).

Upon receiving the transmission format, the transmission data, and the transmission timing of each service from the beacon management server 5, the maintenance communication unit 11 of the beacon device 1 registers the received data in the transmission timing storage unit 12, the transmission format storage unit 13, and the transmission data storage unit 14 (step S151). Further, the maintenance communication unit 11 sends a response to the maintenance management server 5 as necessary to indicate whether registration of the received data has been successfully completed, for example (step S152).

Then, the maintenance communication unit 56 of the beacon management server 5 registers information specifying that data setting of each beacon device 1 has been completed in the maintenance result storage unit 57 as a maintenance result (step S156).

Then, in subsequent operations, the beacon transmission execution unit 15 of the beacon device 1 sequentially transmits the transmission data registered in the transmission data storage unit 14 as beacon signals to the surroundings, in the transmission format registered in the transmission format storage unit 13, based on the transmission timing registered in the transmission timing storage unit 12 (step S154).

When a mobile terminal 4 located in the vicinity of the beacon device 1 receives the beacon signal (step S155), if the beacon device 1 is registered in advance in the mobile terminal 4, the mobile terminal 4 extracts the data included in the beacon signal and passes the extracted data to the beacon utilizing application 42 (step S156).

Then, the beacon utilizing application 42 sends a request for content to a corresponding content server 3 (step S157), and the content server 3 sends a response including the requested content to the mobile terminal 4 (step S158).

As described above, according to embodiments of the present invention, beacon signals of a plurality of services may be transmitted using one beacon device 1 per location.

Also, note that the beacon management server 5 does not necessarily have to be included in a system according to an embodiment of the present invention. For example, in some embodiments, the beacon device 1 may be configured to implement the functions of the beacon management server 5.

Although the present invention has been described above with reference to certain illustrative embodiments, the present invention is not limited to these embodiments, and numerous variations and modifications may be made without departing from the scope of the present invention.

What is claimed is:

1. A beacon transmitting device comprising:
a memory storing a program; and
a processor configured to execute the program to implement processes of
receiving transmission timings, transmission formats, and transmission data for a plurality of beacon signal specifications;
registering the transmission timings, the transmission formats, and the transmission data for the plurality of beacon signal specifications in the memory; and
sequentially transmitting a plurality of beacon signals of the plurality of beacon signal specifications based on the transmission timings, the transmission formats, and the transmission data registered in the memory.

2. The beacon transmitting device according to claim 1, wherein the processor transmits more than one beacon signal of more than one of the plurality of beacon signal specifications at the same time.

3. The beacon transmitting device according to claim 1, wherein the processor transmits a beacon signal including encrypted data.

4. The beacon transmitting device according to claim 1, wherein the plurality of beacon signal specifications includes a beacon signal specification for on-site maintenance.

5. The beacon transmitting device according to claim 1, wherein the processor implements processes of
scheduling the transmission timings for the plurality of beacon signal specifications based on transmission intervals specified by the plurality of beacon signal specifications; and
prioritizing the transmission timing for a beacon signal specification with a shorter transmission interval when the transmission timings for at least two of the plurality of beacon signal specifications overlap with one another.

6. The beacon transmitting device according to claim 1, wherein the processor implements processes of
scheduling the transmission timings for the plurality of beacon signal specifications based on transmission intervals specified by the plurality of beacon signal specifications; and
moving the transmission timing for a beacon signal specification with a longer transmission interval to an open time when the transmission timings for at least two of the plurality of beacon signal specifications overlap with one another.

7. The beacon transmitting device according to claim 1, wherein the processor implements processes of
receiving a beacon signal coming from outside; and
correcting at least one of the transmission timings and the transmission formats registered in the memory to avoid interference from the beacon signal coming from the outside.

8. A beacon transmitting method implemented by a beacon transmitting device, the beacon transmitting method comprising:
receiving transmission timings, transmission formats, and transmission data for a plurality of beacon signal specifications;
registering the transmission timings, the transmission formats, and the transmission data for the plurality of beacon signal specifications in a memory; and
sequentially transmitting a plurality of beacon signals of the plurality of beacon signal specifications based on the transmission timings, the transmission formats, and the transmission data registered in the memory.

9. A non-transitory computer-readable medium storing a program that, when executed, causes a computer included in a beacon transmitting device to implement processes of
receiving transmission timings, transmission formats, and transmission data for a plurality of beacon signal specifications;
registering the transmission timings, the transmission formats, and the transmission data for the plurality of beacon signal specifications in a memory; and
sequentially transmitting a plurality of beacon signals of the plurality of beacon signal specifications based on the transmission timings, the transmission formats, and the transmission data registered in the memory.

10. The non-transitory computer-readable medium according to claim 9, wherein the program causes the computer to implement processes of
transmitting more than one beacon signal of more than one of the plurality of beacon signal specifications at the same time; and
transmitting a beacon signal including encrypted data.

11. The non-transitory computer-readable medium according to claim 9, wherein the program causes the computer to implement processes of
transmitting more than one beacon signal of more than one of the plurality of beacon signal specifications at the same time;
scheduling the transmission timings for the plurality of beacon signal specifications based on transmission intervals specified by the plurality of beacon signal specifications; and
prioritizing the transmission timing for a beacon signal specification with a shorter transmission interval when the transmission timings for at least two of the plurality of beacon signal specifications overlap with one another.

12. The non-transitory computer-readable medium according to claim 9, wherein the program causes the computer to implement processes of
transmitting a beacon signal including encrypted data;
scheduling the transmission timings for the plurality of beacon signal specifications based on transmission intervals specified by the plurality of beacon signal specifications; and
prioritizing the transmission timing for a beacon signal specification with a shorter transmission interval when the transmission timings for at least two of the plurality of beacon signal specifications overlap with one another.

13. The non-transitory computer-readable medium according to claim 9, wherein the program causes the computer to implement processes of
transmitting more than one beacon signal of more than one of the plurality of beacon signal specifications at the same time;
receiving a beacon signal coming from outside; and
correcting at least one of the transmission timings and the transmission formats registered in the memory to avoid interference from the beacon signal coming from the outside.

14. The non-transitory computer-readable medium according to claim 9, wherein the program causes the computer to implement processes of
transmitting a beacon signal including encrypted data;
receiving a beacon signal coming from outside; and
correcting at least one of the transmission timings and the transmission formats registered in the memory to avoid interference from the beacon signal coming from the outside.

15. The non-transitory computer-readable medium according to claim 9, wherein the program causes the computer to implement processes of
scheduling the transmission timings for the plurality of beacon signal specifications based on transmission intervals specified by the plurality of beacon signal specifications;
prioritizing the transmission timing for a beacon signal specification with a shorter transmission interval when the transmission timings for at least two of the plurality of beacon signal specifications overlap with one another;
receiving a beacon signal coming from outside; and
correcting at least one of the transmission timings and the transmission formats registered in the memory to avoid interference from the beacon signal coming from the outside.

16. The non-transitory computer-readable medium according to claim 9, wherein the program causes the computer to implement processes of
scheduling the transmission timings for the plurality of beacon signal specifications based on transmission intervals specified by the plurality of beacon signal specifications;
moving the transmission timing for a beacon signal specification with a longer transmission interval to an open time when the transmission timings for at least two of the plurality of beacon signal specifications overlap with one another;
receiving a beacon signal coming from outside; and
correcting at least one of the transmission timings and the transmission formats registered in the memory to avoid interference from the beacon signal coming from the outside.

17. The non-transitory computer-readable medium according to claim 9, wherein the program causes the computer to implement processes of
transmitting more than one beacon signal of more than one of the plurality of beacon signal specifications at the same time;
scheduling the transmission timings for the plurality of beacon signal specifications based on transmission intervals specified by the plurality of beacon signal specifications; and
moving the transmission timing for a beacon signal specification with a longer transmission interval to an open time when the transmission timings for at least two of the plurality of beacon signal specifications overlap with one another.

18. The non-transitory computer-readable medium according to claim 9, wherein the program causes the computer to implement processes of
transmitting a beacon signal including encrypted data;
scheduling the transmission timings for the plurality of beacon signal specifications based on transmission intervals specified by the plurality of beacon signal specifications; and
moving the transmission timing for a beacon signal specification with a longer transmission interval to an open time when the transmission timings for at least two of the plurality of beacon signal specifications overlap with one another.

19. The non-transitory computer-readable medium according to claim 9, wherein the program causes the computer to implement processes of
scheduling the transmission timings for the plurality of beacon signal specifications based on transmission intervals specified by the plurality of beacon signal specifications; and
prioritizing the transmission timing for a beacon signal specification with a shorter transmission interval and moving the transmission timing for a beacon signal specification with a longer transmission interval to an open time when the transmission timings for at least two of the plurality of beacon signal specifications overlap with one another.
